(19) United States
(12) Patent Application Publication
(10) Pub. No.: US 2008/0009337 A1
(43) Pub. Date: Jan. 10, 2008

(54) Self-authenticating file system in an embedded gaming device

(76) Inventors: Mark D. Jackson, Fort Collins, CO (US); Alan D. Williams, Wilmington, NC (US)

Correspondence Address: MTD Gaming Inc, 2737 Timberchase Trail, Littleton, CO, 80126, US

(21) Appl. No.: 11/825,595

(22) Filed: Jul. 6, 2007

Related U.S. Application Data
(60) Provisional application No. 60/819,797, filed on Jul. 8, 2006.

(51) Int. Cl. A63F 9/24; G06F 17/30

(52) U.S. Cl. 463/16; 707/9

(57) ABSTRACT

A method and apparatus for pre-load authentication suitable for use with an operating system in an embedded gaming device. A user-space file system that can automatically authenticate its contents is disclosed. The user-space file system can be deployed on a standalone system or using a client-server model such that a remote system server can coordinate with a local client to perform authentication. By moving the authentication into the file system functional block there is additional assurance that any game code or data stored in the file system cannot be accessed without first performing the required authentication.

### CROSS-REFERENCE TO RELATED APPLICATION

This application claims priority to the following U.S. Provisional Patent Application Ser. No. 60/819,797 and entitled “Self-Authenticating File System in an Embedded Gaming Device,” which is incorporated herein by reference.

### COPYRIGHT NOTICE

A portion of the disclosure of this patent document contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND OF THE INVENTION

Games of chance have been enjoyed by people for thousands of years and have enjoyed increased and widespread popularity in recent times. As with most forms of entertainment, players enjoy playing a wide variety of games and new games. Playing new games adds to the excitement of “gaming.” As is well known in the art and as used herein, the term “gaming” and “gaming devices” are used to indicate that some form of wagering is involved, and that players must make wagers of value, whether actual currency or some equivalent of value, e.g., token or credit.

One popular game of chance is the slot machine. Conventionally, a slot machine is configured for a player to wager something of value, e.g., currency, house token, established credit or other representation of currency or credit. After the wager has been made, the player activates the slot machine to cause a random event to occur. The player wagers that particular random events will occur that will return value to the player. A standard device causes a plurality of reels to spin and ultimately stop, displaying a random combination of some form of indicia, for example, numbers or symbols. If this display contains one of a preselected plurality of winning combinations, the machine releases money into a payout chute or increments a credit meter by the amount won by the player. For example, if a player initially wagered two coins of a specific denomination and that player achieved a payout, that player may receive the same number or multiples of the wager amount in coins of the same denomination as wagered.

There are many different formats for generating the random display of events that can occur to determine payouts in wagering devices. The standard or original format was the use of three reels with symbols distributed over the face of the reel. When the three reels were spun, they would eventually each stop in turn, displaying a combination of three symbols (e.g., with three reels and the use of a single payout line as a row in the middle of the area where the symbols are displayed.) By appropriately distributing and varying the symbols on each of the reels, the random occurrence of predetermined winning combinations can be provided in mathematically predetermined probabilities. By clearly providing for specific probabilities for each of the preselected winning outcomes, precise odds that would control the amount of the payout for any particular combination and the percentage return on wagers for the house could be readily controlled.

Other formats of gaming apparatus that have developed in a progression from the pure slot machine with three reels have dramatically increased with the development of video gaming apparatus. Rather than have only mechanical elements such as wheels or reels that turn and stop to randomly display symbols, video gaming apparatus and the rapidly increasing sophistication in hardware and software have enabled an explosion of new and exciting gaming apparatus. The earlier video apparatus merely imitated or simulated the mechanical slot games in the belief that players would want to play only the same games. Early video games therefore were simulated slot machines. The use of video gaming apparatus to play new games such as draw poker and Keno broke the ground for the realization that there were many untapped formats for gaming apparatus. Now casinos may have hundreds of different types of gaming apparatus with an equal number of significant differences in play. The apparatus may vary from traditional three reel slot machines with a single payout line, video simulations of three reel video slot machines, to five reel, five column simulated slot machines with a choice of twenty or more distinct pay lines, including randomly placed lines, scatter pays, or single image payouts. In addition to the variation in formats for the play of games, bonus plays, bonus awards, and progressive jackpots have been introduced with great success. The bonuses may be associated with the play of games that are quite distinct from the play of the original game, such as the video display of a horse race with bets on the individual horses randomly assigned to players that qualify for a bonus, the spinning of a random wheel with fixed amounts of a bonus payout on the wheel (or simulation thereof), or attempting to select a random card that is of higher value than a card exposed on behalf of a virtual dealer.

A video terminal is another form of gaming device. Video terminals operate in the same manner as conventional slot or video machines except that a redemption ticket is issued rather than an immediate payout being dispensed.

The vast array of electronic video gaming apparatus that is commercially available is not standardized within the industry or necessarily even within the commercial line of apparatus available from a single manufacturer. One of the reasons for this lack of uniformity or standardization is the fact that the operating systems that have been used to date in the industry are primitive. As a result, the programmer must often create code for each and every function performed by each individual apparatus. To date, no manufacturer prior to the assignee of the present invention is known to have been successful in creating a universal operating system for converting existing equipment (that includes features such as reusable modules of code) at least in part because of the limitations in utility and compatibility of the operating systems in use. When new games are created, new hardware and software is typically created from the ground up.

At least one attempt has been made to create a universal gaming engine that segregates the code associated with random number generation and algorithms applied to the random number string from the balance of the code. Carlson U.S. Pat. No. 5,707,286 describes such a device. This patentee recognized that modular code would be beneficial, but only contemplated making the RNG and transfer algorithms modular. Another attempt to build and market a slot operating system was the Shuffle Master game operating system that was designed as a two part system, an OS module and a Game module. The OS module presented an Application Programming Interface (API) to the Game module that was used in creating multiple game personalities capable of being run on a single common core.

The lack of a standard operating system has contributed to maintaining an artificially high price for the systems in the market. The use of unique and non-standardized hardware interfaces in the various manufactured video gaming systems is a contributing factor. The different hardware, the different access codes, the different pin couplings, the different harnesses for coupling of pins, the different functions provided from the various pins, and the other various and different configurations within the systems has prevented any standard from developing within the technical field. This is advantageous to the apparatus manufacturer, because the games for each system are provided exclusively by a single manufacturer, and the entire systems can be readily made obsolete, so that the market will have to purchase a complete unit rather than merely replacement software and hardware. Also, competitors cannot easily provide a single game that can be played on different hardware.

The invention of computerized gaming systems that include a common or universal video wagering game controller that can be installed in a broad range of video gaming apparatus without substantial modification to the game controller has made possible the standardization of many components and of corresponding gaming software within gaming systems. Such systems desirably will have functions and features that are specifically tailored to the unique demands of supporting a variety of games and gaming apparatus types, and will do so in a manner that is efficient, secure, and cost-effective.

In addition to making communication between a universal operating system and non-standard machine devices such as coin hoppers, monitors, bill validators and the like possible, it would be desirable to provide security features that enable the operating system to verify that game code and other data has not changed during operation.

Alcorn et al. U.S. Pat. No. 5,643,086 describes a gaming system that is capable of authenticating an application or game program stored on a mass media device such as a CD-ROM, RAM, ROM or other device using hashing and encryption techniques. The mass storage device may be located in the gaming machine, or may be external to the gaming machine. This verification technique therefore will not detect any changes that occur in the code that is executing because it tests the code residing in mass storage prior to loading into RAM. The authenticating system relies on the use of a digital signature and suggests hashing of the entire data set before the encryption and decryption process. See also, Alcorn et al. U.S. Pat. No. 6,106,396 and Alcorn et al. U.S. Pat. No. 6,149,522.

What is still desired is alternative architecture and methods of providing a gaming-specific platform that features secure storage and verification of game code and other data, provides the ability to securely change game code on computerized wagering gaming system, and has the ability to verify that the code has not changed during operation of the gaming machine.

In the field of gaming apparatus security, it is further desired that the game program code be identifiable as certified or approved, such as by the various gaming regulation commissions such as the Nevada Gaming Regulations Commission, New Jersey Gaming Regulations Commission or other regulatory agency.

### SUMMARY OF THE INVENTION

The present invention covers a method and apparatus for pre-load authentication suitable for use in an operating system in an embedded gaming device. A user-space file system that can automatically authenticate its contents is disclosed. Said user-space file system can be deployed on a standalone system or using a client-server model such that a remote system server can coordinate with a local client to perform authentication. By moving the authentication into the file system functional block there is additional assurance that any game code or data stored in the file system cannot be accessed without first performing the required authentication.

### BRIEF DESCRIPTION OF THE FIGURES

FIG. 1 is a Block Diagram of a File System.

FIG. 2 is a Block Diagram of a Client/Server Network File System.

FIG. 3 is a Block Diagram of the Hash Procedure of the present invention.

### DESCRIPTION OF THE INVENTION

It is desirable in a gaming device to be able to authenticate a file or data set as having originated from a certain trusted source or having been approved by a certain gaming regulatory agency. The use of cryptographic encryption for authentication purposes in a gaming device has been a preferred technique (U.S. Pat. No. 5,643,086, U.S. Pat. No. 6,106,396, U.S. Pat. No. 6,149,522) to perform this type of authentication. Other types of cryptographic techniques have been used to validate gaming data or programs during continuous operation of a gaming device (U.S. Pat. No. 6,962,530).

A gaming operating system should automatically perform as many of the mandated gaming-related functions or tasks as possible. Such functions and tasks should happen transparently without the ability for a user-level program to change the behavior of the system. By separating the division of tasks in this manner it is possible to have an unchanging operating system binary together with an API that allows any third party vendor to create programs that dynamically couple to this operating system binary and by doing so automatically gain the benefits of the approved functions and tasks instead of having to write such functions themselves.

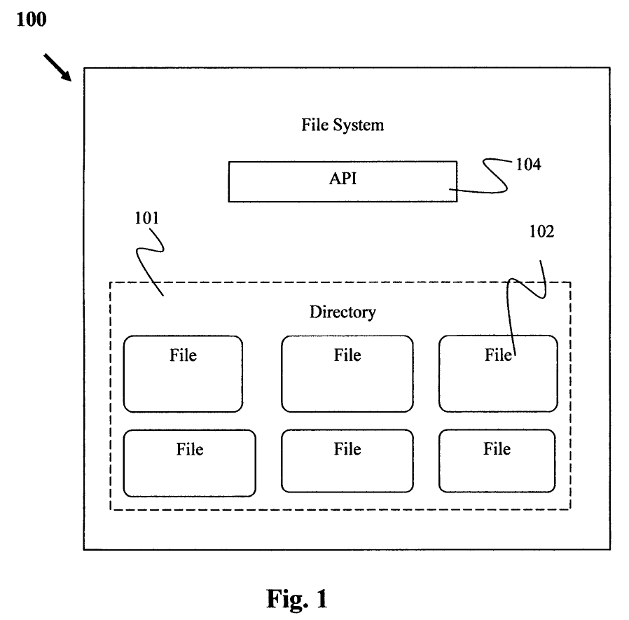

Referring now to FIG. 1, a logical file system 100 is traditionally comprised of memory storage which can be categorized into three parts: data storage, file mapping information, and file metadata information. File mapping information organizes the data storage of the file system traditionally into a hierarchical directory structure that contains directories 101 each of which may contain individual files 102s. This makes it easy to locate data in the underlying data storage typically by the use of a string (i.e. the filename and path) to index into the sections of the data storage that are mapped to the file of interest. Each individual file 102 may include metadata information (data that describes the file), for example, permissions, file length, type of file, author, etc. A file system will also typically provide an Application Programming Interface (API) 104 that includes function calls for use in accessing its logical components. These function calls can be linked statically or dynamically to client applications or alternatively used over a physical network to provide remote or networked file system access.

File systems are typically implemented directly in the operating system kernel due to the fact that they are critical to the operation of the system as a whole, and certain aspects of the file system, such as file access permissions, customarily belong at a level below that of a user program.

The present invention provides for a means for file authentication metadata to be associated with individual files for the purpose of validating the game data sets (which can be code, data or any game-related information) stored in the file system. By handling the authentication in the file system itself, the authentication metadata information need not be visible outside the file system. In addition, in a preferred embodiment, non-authenticated files will not show up in the directory listing at all.

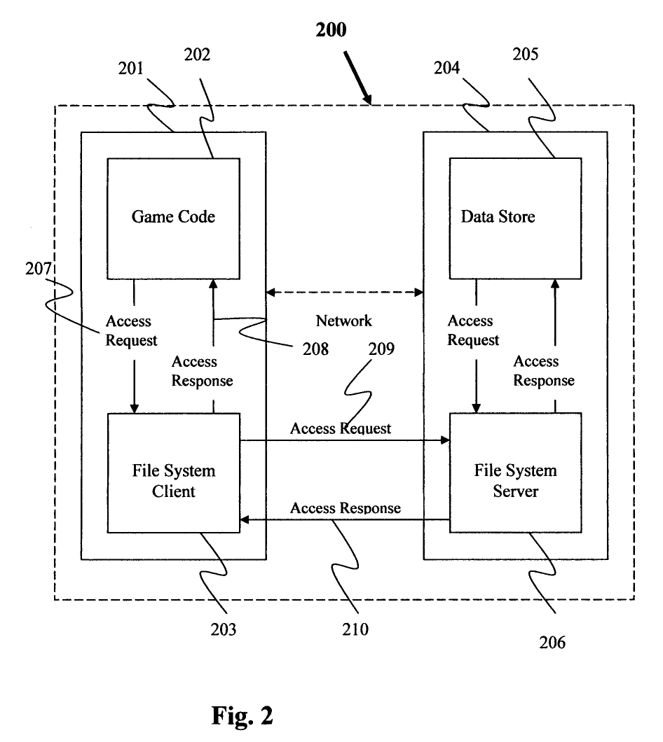

Referring now to FIG. 2, in one embodiment of the system of the invention the system is divided into a client/server arrangement to provide a networked media solution. In this embodiment the physical client 201 and server 204 coexist on a communications network. The game code 202 running on the client (the client in this configuration would be the gaming device itself) requests access to game data residing in a remote file system's data store 205 using local API stubs 203 that are statically linked to said game code in order to issue an access request 207. The local API stubs query the file system API 206 over the communications network using a network access request 209, said access request may employ message level encryption for security. The file system API 206 interrogates the data store 205 through a series of data store accesses 211 and retrieves the information. In some embodiments the file system API 206 performs authentication prior to sending the data over the network to the client. The information is returned using a network access response 210 which in some embodiments can be message level encrypted communications using a stream cipher, block cipher or any other acceptable means. Upon receiving the file information in some embodiments the local API stubs 203 may perform additional authentication to validate the contents as coming from a trusted or authorized source. If the authentication is successful, access is granted and indicated to the game code 202 with a success response 208. If authentication fails, the response returns a “file not found” or other suitable error message to the game code.

Use of client/server communication for the file system in this form may in some embodiments include the use of client-side file caching to improve speed and access times and prevent errors. In this case the file information returned by the server 210 is authenticated and then stored locally in a transient cache for use with further accesses.

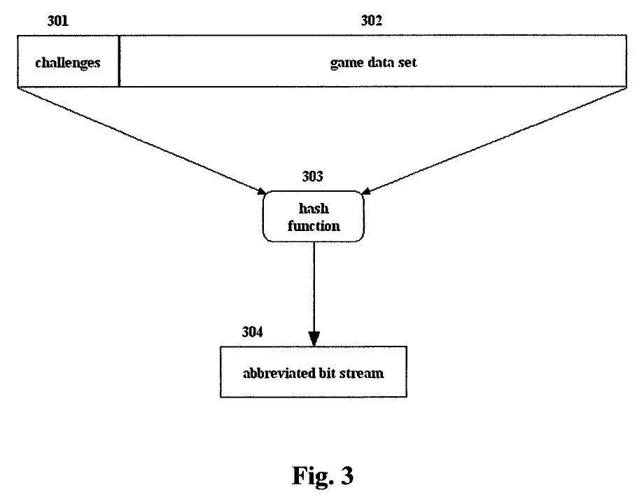

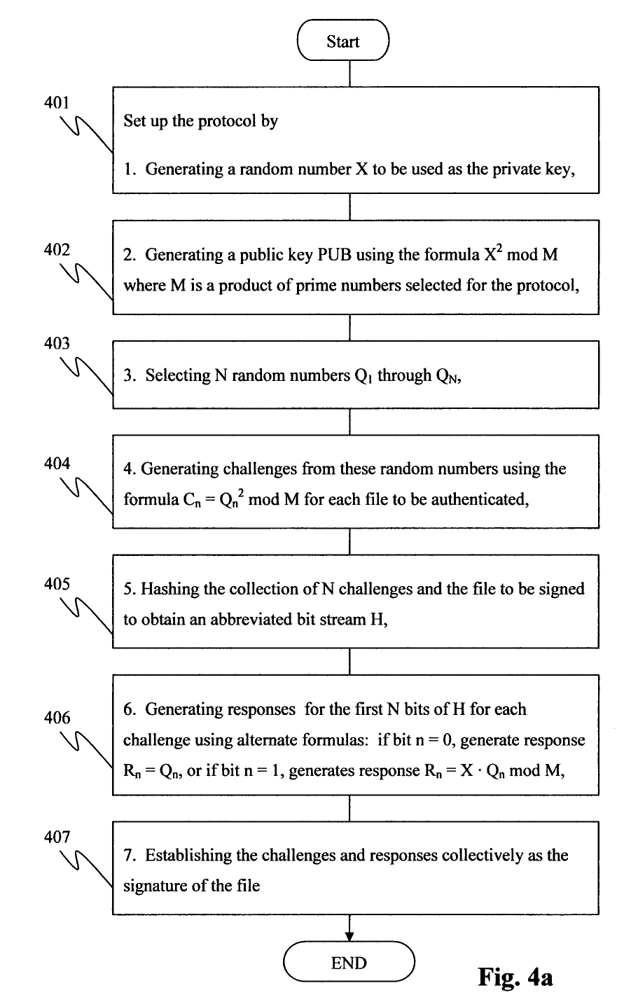

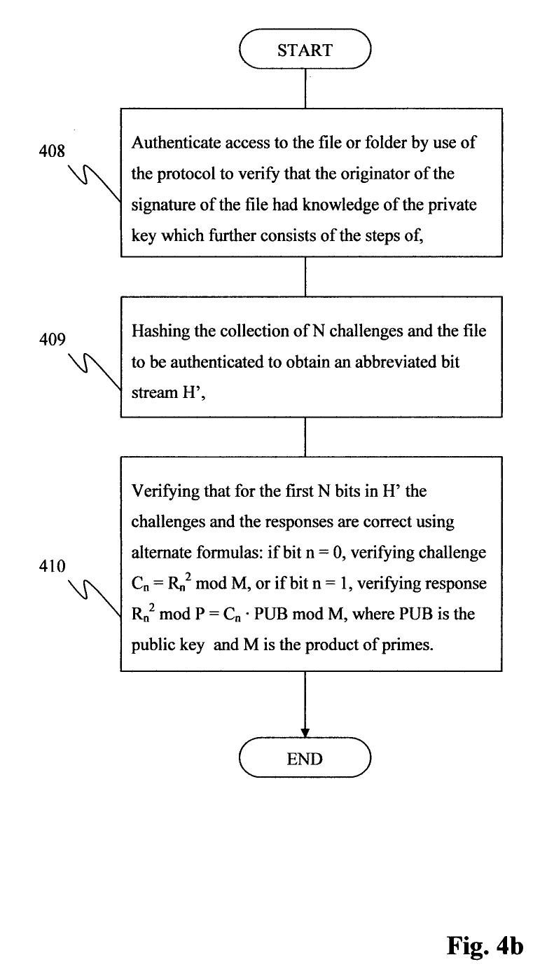

Referring now to FIG. 3 the preferred embodiment of the system of the invention provides for authentication based on challenge/response pairs as part of a zero knowledge proof sequence. Zero knowledge proof (ZKP) pairs as they relate to the system of the invention are comprised of 1) a secret that can be demonstrated without revealing its exact value or its nature, 2) a commitment to a particular choice or problem, 3) a random bit chosen after the commitment, and 4) the ability to be able to complete the protocol no matter which bit is chosen. To achieve this, at least one challenge 301 is combined with at least one game data set 302 and fed into a cryptographic hash function 303 to obtain a hash or abbreviated bit stream 304. Said cryptographic hash function may be any suitable one way hash algorithm such as MD5, SHA-1, SHA-256 or similar. The abbreviated bit stream 304 is used as a series of random bits (step 3 in the ZKP steps) and the challenges 301 represent the commitment stage.

Referring now to FIG. 4a, in the preferred embodiment, to set up the protocol prior to actual deployment in a game, the signer generates a random number X to be used as the private key and stores this private key in a safe place 401. The signer then generates a public key 402 using the formula X² mod M where M is a product of two large prime numbers chosen for the protocol. The modulus M assumed to be known by all parties, however the two large prime numbers used to generate M are secret and should be discarded as they are not necessary to complete the protocol (the purpose of using two large primes to generate M is to make M unfactorable). The public key and the chosen prime number are known by all parties, and in this embodiment the public key and prime are stored in read-only memory storage in the physical gaming apparatus.

To sign a file, directory or other game data, the signer then chooses N random numbers Q₁ through Q_{N} 403 and generates challenges from these random numbers 404 using the formula Cₙ=Qₙ² mod M. The signer hashes the collection 405 of N challenges and the data to be signed to obtain an abbreviated bit stream H. The collection of N challenges and the game data may be combined using any method deemed appropriate, it is only necessary to ensure that the N challenges and the game data (or any bit stream derived from the N challenges and game data) are input to the cryptographic hash function.

Finally, for the first N bits of H, the signer generates responses for each challenge 404 using alternate formulas: if bit n=0, the signer generates response Rₙ=Qₙ, or if bit n=1, the signer 405 generates response Rₙ=XQₙ, mod M. The challenges and responses generated by the signer 406 are collectively taken to be the signature of the file 407.

Referring now to FIG. 4b, once a file has been signed (by a signer, presumably a software manufacturer or a gaming regulatory authority), the authentication 408 in the gaming device proceeds as follows. The authenticator (gaming device) 410 hashes the collection of N challenges 409 and the file to be authenticated to obtain an abbreviated bit stream H′. For the first N bits in H′, the authenticator then verifies that the challenges and the responses are correct using alternate formulas: if bit n=0, the authenticator verifies challenge Cₙ=Rₙ² mod M, or if bit n=1, the authenticator verifies that response Rₙ² mod M=Cₙ·PUB mod M, where PUB is the public key stored in the gaming device and M is the product of primes stored in the gaming device.

Using this protocol, the authenticator has verified that the signer has knowledge of the private key, otherwise they would not be able to complete the zero knowledge responses for bits=1. In addition, the authenticator knows that the zero knowledge responses were generated with knowledge of the bit pattern H′, because a cheater can cheat the protocol with probability 0.5 for each bit, so for N sufficiently large, the probability of successfully completing the protocol becomes arbitrarily small. Finally, because the hash function that generated H′ is a one-way hash function, the authenticator can assume that the original file is valid and intact, because even a one-bit error in the original file will result in a completely different bit pattern that would cause the zero knowledge sequence to fail. Hence, the file has been validated without requiring an encryption of any hash value, as with a typical digital signature such as the one specified in prior art (Alcorn et al. U.S. Pat. Nos. 5,643,086, 6,106,396 and 6,149,522).

The challenges must be hashed along with the file as the signer is committing to these values. The actual pattern of the abbreviated bit stream is unknown to the signer prior to hashing, but because the signer knows the private key completing the protocol will not be a problem. An impostor that does not know the private key will be able to cheat the protocol with probability (0.5)^{N}. For N=20, the probability is less than 1 in 1 million. Suitable values for N in actual gaming devices will most likely be greater than 60.

In the system of the invention, the challenges and the responses generated by the signer in the process of signing a file become part of the file metadata in the file system on the gaming device (or in the case of a networked client server setup, they may reside at either the client or the remote site). In either case, they are not viewable to the end user, only to the file system internally. If a file has a valid signature, the file system control process grants access to the file, otherwise, the file has not been authenticated and is hidden.

It is to be noted that although numerous specific examples have been given to assist in an appreciation and understanding of the generic concepts of this disclosure and inventions included therein, the examples are not intended to be limiting with respect to the claims and the scope of the invention.

1. A file system on an embedded gaming device, wherein access permissions to a directory or file on the file system are determined from the result of performing a cryptographic authentication sequence on at least one directory or file using at least one public key stored on the gaming device and metadata associated with the at least one directory or file.

2. The file system of claim 1, wherein said metadata consists of at least an encrypted hash value.

3. The file system of claim 1, wherein said metadata consists of at least a series of challenge/response pairs.

4. A computerized wagering game apparatus, comprising: a computerized game controller having a processor, memory, random number generator, nonvolatile storage and at least one stored game data set; an authentication program; wherein the authentication program can verify a zero knowledge proof sequence consisting of a series of challenge/response pairs; wherein the authentication program accesses at least one stored game data set in order to authenticate it; wherein prior to loading the game data set into random access memory a bit stream based on at least one zero knowledge response is compared to a bit stream based on at least one zero knowledge challenge; wherein verification comprises verifying that the zero knowledge proof sequence has been completed correctly.

5. A method for determining access permissions to a directory or file on an embedded gaming device comprising the steps of:
a. Setting up the protocol, which further consists of the steps of,
i. generating a random number X to be used as the private key,
ii. generating a public key PUB using the formula X² mod M where M is a product of prime numbers selected for the protocol,
iii. selecting N random numbers Q₁ through Q_{N},
iv. generating challenges from these random numbers using the formula Cₙ=Qₙ² mod M for each file to be authenticated,
v. hashing the collection of N challenges and the file to be signed to obtain an abbreviated bit stream H,
vi. generating responses for the first N bits of H for each challenge using alternate formulas: if bit n=0, generate response Rₙ=Qₙ, or if bit n=1, generates response Rₙ=X·Qₙ mod M,
vii. establishing the challenges and responses collectively as the signature of the file; and
b. Authenticating access to the file or folder by use of the protocol to verify that the originator of the signature of the file had knowledge of the private key which further consists of the steps of,
i. hashing the collection of N challenges and the file to be authenticated to obtain an abbreviated bit stream H′,
ii. verifying that for the first N bits in H′ the challenges and the responses are correct using alternate formulas: if bit n=0, verifying challenge Cₙ=Rₙ² mod M, or if bit n=1, verifying response Rₙ² mod M=Cₙ·PUB mod M, where PUB is the public key and M is the product of prime numbers.

6. The method of claim 5 wherein the step of setting up the protocol is performed by a game manufacturer.

7. The method of claim 5 wherein the step of setting up the protocol is performed by a gaming regulatory authority.

8. The method of claim 5 wherein the step of setting up the protocol is performed by an authorized third party.

9. The method of claim 5 wherein the step of authenticating access to the file or folder is performed in a gaming device.

10. The method of claim 5 wherein the step of authenticating access to the file or folder is performed at a remote site connected to the gaming device over a network.
